(19) United States
(12) Patent Application Publication
(10) Pub. No.: US 2018/0353958 A1
(43) Pub. Date: Dec. 13, 2018

(54) ELASTOMERIC GASKET FOR FLUID INTERFACE TO A MICROFLUIDIC CHIP

(71) Applicant: President and Fellows of Harvard College, Cambridge, MA (US)

(72) Inventors: Christopher David Hinojosa, Cambridge, MA (US); Daniel Levner, Brookline, MA (US)

(21) Appl. No.: 15/781,235

(22) PCT Filed: Dec. 2, 2016
(86) PCT No.: PCT/US16/64742

§ 371 Date: Jun. 4, 2018

Related U.S. Application Data
(60) Provisional application No. 62/263,272, filed on Dec. 4, 2015.

(51) Int. Cl. B01L 3/00; C09K 3/00; C08F 212/08; B01J 4/00; B01L 9/00

(52) U.S. Cl. CPC B01L 3/502715; C09K 3/00; C08F 212/08; B01J 4/001; B01L 2300/0838; B01L 9/54; B01L 2200/0689; B01L 2300/0816; B01L 3/565

(57) ABSTRACT

The present invention relates to microfluidic systems, devices and methods. More specifically, the invention relates to gaskets for sealing fluid interfaces in microfluidic systems and devices.

### CROSS-REFERENCE TO RELATED APPLICATIONS

This application claims priority to and benefit of U.S. Provisional Patent Application Ser. No. 62/263,272, filed on Dec. 4, 2015, which is hereby incorporated by reference herein in its entirety.

### GOVERNMENT SUPPORT

The invention was made with Government Support under Contract No. W911NF-12-2-0036 awarded by the U.S. Army Research Office. The government has certain rights in the invention.

### FIELD OF THE INVENTION

The present disclosure relates to microfluidic systems, devices and methods. More specifically, the invention relates to gaskets for sealing fluid interfaces in microfluidic systems and devices.

### BACKGROUND OF THE INVENTION

For microfluidic chips, it is important to establish a reliable fluid interface. The mechanism(s) employed to introduce a sample fluid into the microfluidic channel, such as tubing or pipettes, is typically inserted in a simple linear motion, and it is important that a reliable seal be established in the first attempt to avoid fluid loss or sample contamination. The seal should be able to withstand and hold a reasonable pressure. Furthermore, the seal component is ideally suitable for use with both water and oil based fluids.

### SUMMARY OF THE INVENTION

The present disclosure relates to microfluidic systems, devices and methods. More specifically, the invention relates to gaskets for sealing fluid interfaces in microfluidic systems.

This disclosure is described in preferred embodiments in the following description with reference to the figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the disclosure can be combined in any suitable manner in one or more embodiments. In the following description, numerous specific details are recited to provide a thorough understanding of embodiments of the disclosure. One skilled in the relevant art will recognize, however, that aspects of the disclosure can be practiced without one or more of the specific details, or with other methods, components, materials, and so forth. In other instances, well-known structures, materials, or operations are not shown or described in detail to avoid obscuring aspects of the disclosure.

In one embodiment, the disclosure contemplates a microfluidic device, including: a member defining at least one internal channel and at least one port in fluid communication with each of the channels; and a gasket associated with each of the ports and configured to sealingly receive a fluid transport mechanism including fluid, such that said fluid can exit the transport mechanism and enter one of the channels, or such that said fluid can exit one or more of the channels and enter the fluid transport mechanism. In one embodiment, the gasket can comprise an elastomeric material comprised of styrene ethylene butylene styrene (SEBS). In one embodiment, the fluid transport mechanism can be a pipette or a tube. In one embodiment, at least a portion of the gasket can fit at least partially into the port. In one embodiment, at least a portion of the gasket can be retained against the microfluidic device by means of a second substrate. In one embodiment, at least a portion of the gasket can be bonded to said microfluidic device. In one embodiment, the member includes a top piece adhered to a bottom piece. In one embodiment, the bottom piece defines the channels and the top piece defines the ports. In some embodiments, gaskets of the present invention may be made of hydrogenated rubber styrene-ethylene/butylene-styrene (SEBS), Styrene Butylene Styrene, styrene-ethylene/propylene-styrene (SEPS), styrene-butadiene rubber, rubber styrene-butadiene-styrene block copolymer (SBS), and rubber blocks or the like.

In one embodiment, the disclosure contemplates a method of engaging a microfluidic device with a fluid transport mechanism. The method includes providing a fluid transport mechanism, including fluid, and a microfluidic device. The microfluidic device includes a member defining at least one internal channel and at least one port in fluid communication with each of the channels. The microfluidic device further includes a gasket associated with each of the ports. In one embodiment, the elastomeric gasket can be formed of styrene ethylene butylene styrene and be configured to sealingly engage said fluid transport mechanism. The method further includes sealingly engaging said microfluidic device with said fluid transport mechanism. In one embodiment, the engaging is under conditions such that said fluid exits the fluid transport mechanism and enters one of the channels. In one embodiment, the engaging is under conditions such that the fluid exits one or more of the channels and enters the fluid transport mechanism. In one embodiment, the fluid transport mechanism is a pipette or a tube. In one embodiment, at least a portion of the gasket fits at least partially into the port. In one embodiment, at least a portion of the gasket is retained against the microfluidic device by means of a second substrate. In one embodiment, at least a portion of the gasket is bonded to said microfluidic device. In one embodiment, the member includes a top piece adhered to a bottom piece. In one embodiment, the bottom piece defines the channels and the top piece defines the ports. In some embodiments, gaskets of the present invention may be made of hydrogenated rubber styrene-ethylene/butylene-styrene (SEBS), Styrene Butylene Styrene, styrene-ethylene/propylene-styrene (SEPS), styrene-butadiene rubber, rubber styrene-butadiene-styrene block copolymer (SBS), and rubber blocks or the like.

In one embodiment, the invention contemplates a cartridge for use with a microfluidic analysis system, including: a) a carrier; and b) a microfluidic device disposed within the carrier, said microfluidic device including i) a member defining ii) at least one internal channel and iii) at least one port in fluid communication with each of the channels, said microfluidic device further including iv) an elastomeric face seal comprised of styrene ethylene butylene styrene. In one embodiment, said elastomeric face seal is a planar seal. In one embodiment, said elastomeric face seal is in contact with said carrier. In one embodiment, said elastomeric face seal includes one or more microfluidic vias extending through the elastomer face seal and in fluid connection with one or more of said ports. In one embodiment, said cartridge is disposable. In some embodiments, elastomeric face seal of the present invention may be made of hydrogenated rubber styrene-ethylene/butylene-styrene (SEBS), Styrene Butylene Styrene, styrene-ethylene/propylene-styrene (SEPS), styrene-butadiene rubber, rubber styrene-butadiene-styrene block copolymer (SBS), and rubber blocks or the like.

In one embodiment, the disclosure contemplates an assembly having a manifold frame with openings. The manifold frame is positioned above and engages a gasket with openings. The openings of the gasket are aligned with the openings of the manifold frame. The gasket is positioned above and engages a microfluidic device. The microfluidic device includes at least one internal channel and at least one port in fluid communication with each of the at least one channel. The at least one port is aligned with the openings of the manifold frame and the gasket. The microfluidic device is positioned above and engages a clamping plate.

Other objects, advantages, and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### Definitions

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, “about” or “approximately” shall generally mean within 20 percent, preferably within 10 percent, and more preferably within 5 percent of a given value or range.

The term “molecule” means any distinct or distinguishable structural unit of matter including one or more atoms, and includes for example polypeptides and polynucleotides.

The term “polymer” means any substance or compound that is composed of two or more building blocks (“mers”) that are repetitively linked to each other. For example, a “dimer” is a compound in which two building blocks have been joined together.

The term “polynucleotide” as used herein refers to a polymeric molecule having a backbone that supports bases capable of hydrogen bonding to typical polynucleotides, where the polymer backbone presents the bases in a manner to permit such hydrogen bonding in a sequence specific fashion between the polymeric molecule and a typical polynucleotide (e.g., single-stranded DNA). Such bases are typically inosine, adenosine, guanosine, cytosine, uracil and thymidine. Polymeric molecules include double and single stranded RNA and DNA, and backbone modifications thereof, for example, methylphosphonate linkages.

Thus, a “polynucleotide” or “nucleotide sequence” is a series of nucleotide bases (also called “nucleotides”) generally in DNA and RNA, and means any chain of two or more nucleotides. A nucleotide sequence typically carries genetic information, including the information used by cellular machinery to make proteins and enzymes. These terms include double or single stranded genomic and cDNA, RNA, any synthetic and genetically manipulated polynucleotide, and both sense and anti-sense polynucleotide (although only sense stands are being represented herein). This includes single- and double-stranded molecules, i.e., DNA-DNA, DNA-RNA and RNA-RNA hybrids, as well as “protein nucleic acids” (PNA) formed by conjugating bases to an amino acid backbone. This also includes nucleic acids containing modified bases, for example thio-uracil, thio-guanine and fluoro-uracil.

The polynucleotides herein may be flanked by natural regulatory sequences, or may be associated with heterologous sequences, including promoters, enhancers, response elements, signal sequences, polyadenylation sequences, introns, 5′- and 3′-non-coding regions, and the like. The nucleic acids may also be modified by many means known in the art. Non-limiting examples of such modifications include methylation, “caps”, substitution of one or more of the naturally occurring nucleotides with an analog, and internucleotide modifications such as, for example, those with uncharged linkages (e.g., methyl phosphonates, phosphotriesters, phosphoroamidates, carbamates, etc.) and with charged linkages (e.g., phosphorothioates, phosphorodithioates, etc.). Polynucleotides may contain one or more additional covalently linked moieties, such as, for example, proteins (e.g., nucleases, toxins, antibodies, signal peptides, poly-L-lysine, etc.), intercalators (e.g., acridine, psoralen, etc.), chelators (e.g., metals, radioactive metals, iron, oxidative metals, etc.), and alkylators. The polynucleotides may be derivatized by formation of a methyl or ethyl phosphotriester or an alkyl phosphoramidate linkage. Furthermore, the polynucleotides herein may also be modified with a label capable of providing a detectable signal, either directly or indirectly. Exemplary labels include radioisotopes, fluorescent molecules, biotin, and the like.

The term “dielectrophoretic force gradient” means a dielectrophoretic force is exerted on an object in an electric field provided that the object has a different dielectric constant than the surrounding media. This force can either pull the object into the region of larger field or push it out of the region of larger field. The force is attractive or repulsive depending respectively on whether the object or the surrounding media has the larger dielectric constant.

“DNA” (deoxyribonucleic acid) means any chain or sequence of the chemical building blocks adenine (A), guanine (G), cytosine (C) and thymine (T), called nucleotide bases, that are linked together on a deoxyribose sugar backbone. DNA can have one strand of nucleotide bases, or two complimentary strands which may form a double helix structure. “RNA” (ribonucleic acid) means any chain or sequence of the chemical building blocks adenine (A), guanine (G), cytosine (C) and uracil (U), called nucleotide bases, that are linked together on a ribose sugar backbone. RNA typically has one strand of nucleotide bases.

A “polypeptide” (one or more peptides) is a chain of chemical building blocks called amino acids that are linked together by chemical bonds called peptide bonds. A “protein” is a polypeptide produced by a living organism. A protein or polypeptide may be “native” or “wild-type”, meaning that it occurs in nature; or it may be a “mutant”, “variant” or “modified”, meaning that it has been made, altered, derived, or is in some way different or changed from a native protein, or from another mutant.

A “small molecule” as used herein, is meant to refer to a composition that has a molecular weight of less than about 5 kD and most preferably less than about 4 kD. Small molecules can be, e.g., nucleic acids, peptides, polypeptides, peptidomimetics, carbohydrates, lipids or other organic or inorganic molecules. Libraries of chemical and/or biological mixtures, such as fungal, bacterial, or algal extracts, are known in the art.

As used herein, “cell” means any cell or cells, as well as viruses or any other particles having a microscopic size, e.g., a size that is similar to or smaller than that of a biological cell, and includes any prokaryotic or eukaryotic cell, e.g., bacteria, fungi, plant and animal cells. Cells are typically spherical, but can also be elongated, flattened, deformable and asymmetrical, i.e., non-spherical. The size or diameter of a cell typically ranges from about 0.1 to 120 microns, and typically is from about 1 to 50 microns. A cell may be living or dead. Since the microfabricated device of the invention is directed to sorting materials having a size similar to a biological cell (e.g., about 0.1 to 120 microns) or smaller (e.g., about 0.1 to 150 nm) any material having a size similar to or smaller than a biological cell can be characterized and sorted using the microfabricated device of the invention. Thus, the term cell shall further include liposomes, emulsions, or any other encapsulating biomaterials and porous materials. Non-limiting examples include vesicles such as emulsions and liposomes. As used herein, a cell may be charged or uncharged. Biological cells, living or dead, may be charged for example by using a surfactant, such as SDS (sodium dodecyl sulfate). The term cell further encompasses “virions”, whether or not virions are expressly mentioned.

A “reporter” is any molecule, or a portion thereof, that is detectable, or measurable, for example, by optical detection. In addition, the reporter associates with a molecule, cell or virion or with a particular marker or characteristic of the molecule, cell or virion, or is itself detectable to permit identification of the molecule, cell or virion's, or the presence or absence of a characteristic of the molecule, cell or virion. In the case of molecules such as polynucleotides such characteristics include size, molecular weight, the presence or absence of particular constituents or moieties (such as particular nucleotide sequences or restrictions sites). In the case of cells, characteristics which may be marked by a reporter includes antibodies, proteins and sugar moieties, receptors, polynucleotides, and fragments thereof. The term “label” can be used interchangeably with “reporter”. The reporter is typically a dye, fluorescent, ultraviolet, or chemiluminescent agent, chromophore, or radio-label, any of which may be detected with or without some kind of stimulatory event, e.g., fluoresce with or without a reagent. In one embodiment, the reporter is a protein that is optically detectable without a device, e.g., a laser, to stimulate the reporter, such as horseradish peroxidase (HRP). A protein reporter can be expressed in the cell that is to be detected, and such expression may be indicative of the presence of the protein or it can indicate the presence of another protein that may or may not be coexpressed with the reporter. A reporter may also include any substance on or in a cell that causes a detectable reaction, for example by acting as a starting material, reactant or a catalyst for a reaction which produces a detectable product. Cells may be sorted, for example, based on the presence of the substance, or on the ability of the cell to produce the detectable product when the reporter substance is provided.

A “marker” is a characteristic of a molecule, cell or virion that is detectable or is made detectable by a reporter, or which may be coexpressed with a reporter. For molecules, a marker can be particular constituents or moieties, such as restrictions sites or particular nucleic acid sequences in the case of polynucleotides. For cells and virions, characteristics may include a protein, including enzyme, receptor and ligand proteins, saccharides, polynucleotides, and combinations thereof, or any biological material associated with a cell or virion. The product of an enzymatic reaction may also be used as a marker. The marker may be directly or indirectly associated with the reporter or can itself be a reporter. Thus, a marker is generally a distinguishing feature of a molecule, cell or virion, and a reporter is generally an agent which directly or indirectly identifies or permits measurement of a marker. These terms may, however, be used interchangeably.

### DESCRIPTION OF THE FIGURES

The accompanying figures, which are incorporated into and form a part of the disclosure, illustrate several embodiments of the present invention and, together with the description, serve to explain the principles of the invention. The figures are only for the purpose of illustrating a preferred embodiment of the invention and are not to be construed as limiting the invention.

FIG. 1 depicts a microfluidic chip, including a gasket and a fluidic plate, with the gasket disposed between the fluidic plate and a fluid transport mechanism, in accord with aspects of the present disclosure.

FIG. 2 depicts a cross-section view of the microfluidic chip of FIG. 1 that includes one or more port structures that include a tapered lead directly in a microfluidic channel, and the gasket that contains matching tapered bosses configured to fit within the port structures, in accord with aspects of the present disclosure.

FIG. 3 depicts the cross-section view of the use of a fluid transport mechanism to position and seal the gasket depicted in FIG. 2 within a port, in accord with aspects of the present disclosure.

FIG. 4 illustrates interconnects for each tube molded into a single monolithic self-aligned structure, in accord with aspects of the present disclosure.

FIG. 5A depicts a front/top perspective of an exemplary embodiment of a gasket interface for use with a microfluidic chip according to the invention, in accord with aspects of the present disclosure.

FIG. 5B depicts a side perspective of the gasket depicted in FIG. 5A, in accord with aspects of the present disclosure.

FIG. 5C depicts a cross-section of the gasket interface depicted in FIG. 5A, in accord with aspects of the present disclosure.

FIG. 6 depicts a cross-section of the fluid interface with an exemplary microfluidic chip using the gasket shown in FIG. 5A, in accord with aspects of the present disclosure.

FIG. 7 shows is an enlarged perspective of the fluid interface shown in FIG. 6, in accord with aspects of the present disclosure.

FIG. 8 depicts an example of a cartridge with an organ chip clamped in place, in accord with aspects of the present disclosure.

FIG. 9A shows an exploded view of a rigid-chip interface system, in accord with aspects of the present disclosure.

FIG. 9B shows an assembled view of the rigid-chip interface system of FIG. 9A, in accord with aspects of the present disclosure.

FIG. 10 depicts the system of FIGS. 9A and 9B in use, in accord with aspects of the present disclosure.

FIG. 11 shows a cross-section view of a gasket making a face-seal between a chip and a cartridge, in accord with aspects of the present disclosure.

FIG. 12 shows a cross-section view of a gasket making a face-seal against a chip and a radial seal against an inserted tube or nozzle, in accord with aspects of the present disclosure.

FIG. 13 shows a cross-section view of a gasket making a face-seal against a chip and a radial seal with a pipette tip, in accord with aspects of the present disclosure.

FIG. 14 shows a cross-section view of a gasket making a radial-seal between a first component and a radial seal with a second component, in accord with aspects of the present disclosure.

### DETAILED DESCRIPTION OF THE INVENTION

The present invention relates to microfluidic systems, devices and methods. More specifically, the invention relates to gaskets for sealing fluid interfaces in microfluidic systems.

### Substrates

In one embodiment, the microfluidic device of the present invention includes one or more analysis units. An “analysis unit” is a micro substrate, e.g., a microchip. The terms microsubstrate, substrate, microchip, and chip are used interchangeably herein. The analysis unit includes at least one inlet channel, at least one main channel, at least one inlet module, and at least one detection module. The analysis unit can further include one or more sorting modules. The sorting module can be in fluid communication with branch channels which are in fluid communication with one or more outlet modules (collection module or waste module). For sorting applications, at least one detection module cooperates with at least one sorting module to divert flow via a detector-originated signal. It shall be appreciated that the “modules” and “channels” are in fluid communication with each other and therefore may overlap; i.e., there may be no clear boundary where a module or channel begins or ends. A plurality of analysis units of the invention may be combined in one device. The analysis unit and specific modules are described in further detail herein.

The dimensions of the substrate are those of typical microchips, ranging between about 0.5 cm to about 15 cm per side and about 1 micron to about 1 cm in thickness. A substrate can be transparent and can be covered with a material having transparent properties, such as a glass coverslip, to permit detection of a reporter, for example, by an optical device such as an optical microscope. The material can be perforated for functional interconnects, such as fluidic, electrical, and/or optical interconnects, and sealed to the back interface of the device so that the junction of the interconnects to the device is leak-proof. Such a device can allow for application of high pressure to fluid channels without leaking.

A variety of materials and methods, according to certain aspects of the disclosure, can be used to form any of the described components of the systems and devices of the invention. In some cases, the various materials selected lend themselves to various methods. For example, various components of the invention can be formed from solid materials, in which the channels can be formed via molding, micromachining, film deposition processes, such as spin coating and chemical vapor deposition, laser fabrication, photolithographic techniques, etching methods including wet chemical or plasma processes, and the like. Various components of the systems and devices of the invention can also be formed of a polymer, for example, an elastomeric polymer such as styrene ethylene butylene styrene (SEBS), poly-styrene ethylene butylene styrene, or Kraton polymers, styrenic block copolymer (SBC) consisting of polystyrene blocks and rubber blocks or the like. In some embodiments, gaskets or elastomeric face seals of the present invention may be made of hydrogenated rubber styrene-ethylene/butylene-styrene (SEBS), styrene butylene styrene, styrene-ethylene/propylene-styrene (SEPS), styrene-butadiene rubber, rubber styrene-butadiene-styrene block copolymer (SBS) and rubber blocks or the like.

### Channels

The microfluidic devices of the present invention include channels that form the boundary for a fluid. A “channel,” as used herein, means a feature on or in a substrate that at least partially directs the flow of a fluid. In some cases, the channel may be formed, at least in part, by a single component, e.g., an etched substrate or molded unit. The channel can have any cross-sectional shape, for example, circular, oval, triangular, irregular, square or rectangular (having any aspect ratio), or the like, and can be covered or uncovered (i.e., open to the external environment surrounding the channel). In embodiments where the channel is completely covered, at least one portion of the channel can have a cross-section that is completely enclosed, and/or the entire channel may be completely enclosed along its entire length with the exception of its inlet and outlet.

An open channel generally will include characteristics that facilitate control over fluid transport, e.g., structural characteristics (an elongated indentation) and/or physical or chemical characteristics (hydrophobicity vs. hydrophilicity) and/or other characteristics that can exert a force (e.g., a containing force) on a fluid. The fluid within the channel may partially or completely fill the channel. In some cases the fluid may be held or confined within the channel or a portion of the channel in some fashion, for example, using surface tension (e.g., such that the fluid is held within the channel within a meniscus, such as a concave or convex meniscus). In an article or substrate, some (or all) of the channels may be of a particular size or less, for example, having a largest dimension perpendicular to fluid flow of less than about 5 mm, less than about 2 mm, less than about 1 mm, less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm or less in some cases. Of course, in some cases, larger channels, tubes, etc. can be used to store fluids in bulk and/or deliver a fluid to the channel. In one embodiment, the channel is a capillary.

The dimensions of the channel may be chosen such that fluid is able to freely flow through the channel, for example, if the fluid contains cells. The dimensions of the channel may also be chosen, for example, to allow a certain volumetric or linear flow rate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, etc.

A “main channel” is a channel of the device of the invention which permits the flow of molecules, cells, or small molecules. In some aspects, the molecules, cells, or small molecules can flow past a coalescence module for coalescing one or more droplets, a detection module for detection (identification) or measurement of a droplet and a sorting module, if present, for sorting a droplet based on the detection in the detection module. The main channel is typically in fluid communication with the coalescence, detection and/or sorting modules, as well as, an inlet channel of the inlet module. The main channel is also typically in fluid communication with an outlet module and optionally with branch channels, each of which may have a collection module or waste module. These channels permit the flow of molecules, cells, or small molecules out of the main channel. An “inlet channel” permits the flow of molecules, cells, or small molecules into the main channel. One or more inlet channels communicate with one or more fluid transport mechanisms or means for introducing a sample into the device of the present invention. The inlet channel communicates with the main channel at an inlet module.

The microfluidic device can also comprise one or more fluid channels to inject or remove fluid in between droplets in a droplet stream for the purpose of changing the spacing between droplets.

The channels of the device of the present invention can be of any geometry as described. However, the channels of the device can comprise a specific geometry such that the contents of the channel are manipulated, e.g., sorted, mixed, prevent clogging, etc.

A microfluidic device can also include a specific geometry designed in such a manner as to prevent the aggregation of biological/chemical material and keep the biological/chemical material separated from each other prior to encapsulation in droplets. The geometry of channel dimension can be changed to disturb the aggregates and break them apart by various methods, that can include, but is not limited to, geometric pinching (to force cells through a (or a series of) narrow region(s), whose dimension is smaller or comparable to the dimension of a single cell) or a barricade (place a series of barricades on the way of the moving cells to disturb the movement and break up the aggregates of cells).

To prevent material (e.g., cells and molecules) from adhering to the sides of the channels, the channels (and coverslip, if used) can have a coating which minimizes adhesion. Such a coating may be intrinsic to the material from which the device is manufactured, or it may be applied after the structural aspects of the channels have been microfabricated. TEFLON™ by Chemours is an example of a coating that has suitable surface properties. The surface of the channels of the microfluidic device can be coated with any anti-wetting or blocking agent for the dispersed phase. The channel can be coated with any protein to prevent adhesion of the biological/chemical sample. In another embodiment, the channels can be coated with a cyclized transparent optical polymer obtained by copolymerization of perfluoro (alkenyl vinyl ethers), such as the type sold by Asahi Glass Co. under the trademark Cytop®. In such an embodiment, the coating is applied from a 0.1-0.5 wt % solution of Cytop CTL-809M in CT-Solv 180. This solution can be injected into the channels of a microfluidic device via a plastic syringe. The device can then be heated to about 90° C. for 2 hours, followed by heating at 200° C. for an additional 2 hours.

### Fluids

The microfluidic device of the present invention is capable of controlling the direction and flow of fluids and entities within the device. The term “flow” means any movement of liquid or solid through a device or in a method of the invention, and encompasses without limitation any fluid stream, and any material moving with, within or against the stream, whether or not the material is carried by the stream. For example, the movement of molecules or cells through a device or in a method of the invention, e.g., through channels of a microfluidic device of the invention, includes a flow. This is so, according to the invention, whether or not the molecules or cells are carried by a stream of fluid also including a flow, or whether the molecules or cells are caused to move by some other direct or indirect force or motivation, and whether or not the nature of any motivating force is known or understood. The application of any force may be used to provide a flow, including without limitation, pressure, capillary action, electro-osmosis, electrophoresis, dielectrophoresis, optical tweezers, and combinations thereof, without regard for any particular theory or mechanism of action, so long as molecules, cells or virions are directed for detection, measurement or sorting according to the invention. Specific flow forces are described in further detail herein.

The flow stream in the main channel is typically, but not necessarily, continuous and may be stopped and started, reversed or changed in speed. A liquid that does not contain sample molecules, or cells can be introduced into a sample inlet well or channel and directed through the inlet module, e.g., by capillary action, to hydrate and prepare the device for use. Likewise, buffer or oil can also be introduced into a main inlet region that communicates directly with the main channel to purge the device (e.g., or “dead” air) and prepare it for use. If desired, the pressure can be adjusted or equalized, for example, by adding buffer or oil to an outlet module.

As used herein, the term “fluid stream” or “fluidic stream” refers to the flow of a fluid, typically generally in a specific direction. The fluidic stream may be continuous and/or discontinuous. A “continuous” fluidic stream is a fluidic stream that is produced as a single entity, e.g., if a continuous fluidic stream is produced from a channel, the fluidic stream, after production, appears to be contiguous with the channel outlet. The continuous fluidic stream is also referred to as a continuous phase fluid or carrier fluid. The continuous fluidic stream may be laminar, or turbulent in some cases.

Similarly, a “discontinuous” fluidic stream is a fluidic stream that is not produced as a single entity. The discontinuous fluidic stream is also referred to as the dispersed phase fluid or sample fluid. A discontinuous fluidic stream may have the appearance of individual droplets, optionally surrounded by a second fluid. A “droplet,” as used herein, is an isolated portion of a first fluid that completely surrounded by a second fluid. In some cases, the droplets may be spherical or substantially spherical; however, in other cases, the droplets may be non-spherical, for example, the droplets may have the appearance of “blobs” or other irregular shapes, for instance, depending on the external environment. As used herein, a first entity is “surrounded” by a second entity if a closed loop can be drawn or idealized around the first entity through only the second entity. The dispersed phase fluid can include a biological/chemical material. The biological/chemical material can be tissues, cells, proteins, antibodies, amino acids, nucleotides, small molecules, and pharmaceuticals. The biological/chemical material can include one or more labels known in the art. The label can be a DNA tag, dyes or quantum dot, or combinations thereof.

### Driving Forces

The invention can use pressure drive flow control, e.g., utilizing valves and pumps, to manipulate the flow of cells, molecules, enzymes or reagents in one or more directions and/or into one or more channels of a microfluidic device. However, other methods may also be used, alone or in combination with pumps and valves, such as electro-osmotic flow control, electrophoresis and dielectrophoresis. Application of these techniques according to the invention provides more rapid and accurate devices and methods for analysis or sorting, for example, because the sorting occurs at or in a sorting module that can be placed at or immediately after a detection module. This provides a shorter distance for molecules or cells to travel, they can move more rapidly and with less turbulence, and can more readily be moved, examined, and sorted in single file, i.e., one at a time.

The pressure at the inlet module can also be regulated by adjusting the pressure on the main and sample inlet channels, for example, with pressurized syringes feeding into those inlet channels. By controlling the pressure difference between the oil and water sources at the inlet module, the size and periodicity of the droplets generated may be regulated. Alternatively, a valve may be placed at or coincident to either the inlet module or the sample inlet channel connected thereto to control the flow of solution into the inlet module, thereby controlling the size and periodicity of the droplets. Periodicity and droplet volume may also depend on channel diameter, the viscosity of the fluids, and shear pressure.

Without being bound by any theory, electro-osmosis is believed to produce motion in a stream containing ions (e.g., a liquid such as a buffer) by application of a voltage differential or charge gradient between two or more electrodes. Neutral (uncharged) molecules or cells can be carried by the stream. Electro-osmosis is particularly suitable for rapidly changing the course, direction or speed of flow. Electrophoresis is believed to produce movement of charged objects in a fluid toward one or more electrodes of opposite charge, and away from one on or more electrodes of like charge. Where an aqueous phase is combined with an oil phase, aqueous droplets are encapsulated or separated from each other by oil. Typically, the oil phase is not an electrical conductor and may insulate the droplets from the electro-osmotic field. In this example, electro-osmosis may be used to drive the flow of droplets if the oil is modified to carry or react to an electrical field, or if the oil is substituted for another phase that is immiscible in water but which does not insulate the water phase from electrical fields.

Dielectrophoresis is believed to produce movement of dielectric objects, which have no net charge, but have regions that are positively or negatively charged in relation to each other. Alternating, non-homogeneous electric fields in the presence of droplets and/or particles, such as cells or molecules, cause the droplets and/or particles to become electrically polarized and thus to experience dielectrophoretic forces. Depending on the dielectric polarizability of the particles and the suspending medium, dielectric particles will move either toward the regions of high field strength or low field strength. For example, the polarizability of living cells depends on their composition, morphology, and phenotype and is highly dependent on the frequency of the applied electrical field. Thus, cells of different types and in different physiological states generally possess distinctly different dielectric properties, which may provide a basis for cell separation, e.g., by differential dielectrophoretic forces. Likewise, the polarizability of droplets also depends upon their size, shape and composition. For example, droplets that contain salts can be polarized.

The term “dielectrophoretic force gradient” means a dielectrophoretic force is exerted on an object in an electric field provided that the object has a different dielectric constant than the surrounding media. This force can either pull the object into the region of larger field or push it out of the region of larger field. The force is attractive or repulsive depending respectively on whether the object or the surrounding media has the larger dielectric constant.

Manipulation is also dependent on permittivity (a dielectric property) of the droplets and/or particles with the suspending medium. Thus, polymer particles, living cells show negative dielectrophoresis at high-field frequencies in water. For example, dielectrophoretic forces experienced by a latex sphere in a 0.5 MV/m field (10 V for a 20 micron electrode gap) in water are predicted to be about 0.2 piconewtons (pN) for a 3.4 micron latex sphere to 15 pN for a 15 micron latex sphere. These values are mostly greater than the hydrodynamic forces experienced by the sphere in a stream (about 0.3 pN for a 3.4 micron sphere and 1.5 pN for a 15 micron sphere). Therefore, manipulation of individual cells or particles can be accomplished in a streaming fluid, such as in a cell sorter device, using dielectrophoresis. Using conventional semiconductor technologies, electrodes can be microfabricated onto a substrate to control the force fields in a microfabricated sorting device of the invention. Dielectrophoresis is particularly suitable for moving objects that are electrical conductors. The use of AC current is preferred, to prevent permanent alignment of ions. Megahertz frequencies are suitable to provide a net alignment, attractive force, and motion over relatively long distances.

Radiation pressure can also be used in the invention to deflect and move objects, e.g., droplets and particles (molecules, cells, particles, etc.) contained therein, with focused beams of light such as lasers. Flow can also be obtained and controlled by providing a pressure differential or gradient between one or more channels of a device or in a method of the invention.

Molecules, cells or particles (or droplets containing molecules, cells or particles) can be moved by direct mechanical switching, e.g., with on-off valves or by squeezing the channels. Pressure control may also be used, for example, by raising or lowering an output well to change the pressure inside the channels on the chip. Different switching and flow control mechanisms can be combined on one chip or in one device and can work independently or together as desired.

### Inlet Module

The microfluidic device of the present invention may include one or more inlet modules. An “inlet module” is an area of a microfluidic device that receives fluid, said fluid optionally containing: molecules, cells, or small molecules for additional coalescence, detection and/or sorting. The inlet module can contain one or more inlet channels, wells or reservoirs, openings, and other features which facilitate the entry of molecules, cells, or small molecules into the substrate. A substrate may contain more than one inlet module if desired. Different sample inlet channels can communicate with the main channel at different inlet modules. Alternately, different sample inlet channels can communicate with the main channel at the same inlet module. The inlet module is in fluid communication with the main channel. The inlet module generally includes a junction between the sample inlet channel and the main channel such that a solution of a sample (e.g., a fluid containing a sample such as molecules, cells, small molecules (organic or inorganic) or particles) is introduced to the main channel and forms a plurality of droplets. The sample solution can be pressurized. The sample inlet channel can intersect the main channel such that the sample solution is introduced into the main channel at an angle perpendicular to a stream of fluid passing through the main channel. For example, the sample inlet channel and main channel intercept at a T-shaped junction; i.e., such that the sample inlet channel is perpendicular (90 degrees) to the main channel. However, the sample inlet channel can intercept the main channel at any angle, and need not introduce the sample fluid to the main channel at an angle that is perpendicular to that flow. The angle between intersecting channels is in the range of from about 60 to about 120 degrees. Particular exemplary angles are 45, 60, 90, and 120 degrees.

Embodiments of the invention are also provided in which there are two or more inlet modules introducing droplets of samples into the main channel. For example, a first inlet module may introduce droplets of a first sample into a flow of fluid in the main channel and a second inlet module may introduce droplets of a second sample into the flow of fluid in main channel, and so forth. The second inlet module is preferably downstream from the first inlet module (e.g., about 30 μm). The fluids introduced into the two or more different inlet modules can comprise the same fluid or the same type of fluid (e.g., different aqueous solutions). For example, droplets of an aqueous solution containing an enzyme are introduced into the main channel at the first inlet module and droplets of aqueous solution containing a substrate for the enzyme are introduced into the main channel at the second inlet module. Alternatively, the droplets introduced at the different inlet modules may be droplets of different fluids which may be compatible or incompatible. For example, the different droplets may be different aqueous solutions, or droplets introduced at a first inlet module may be droplets of one fluid (e.g., an aqueous solution) whereas droplets introduced at a second inlet module may be another fluid (e.g., alcohol or oil).

### Reservoir/Well

A device of the invention can include a sample solution reservoir or well or other fluid transport mechanism or apparatus for introducing a sample to the device, at the inlet module, which is typically in fluid communication with an inlet channel. Reservoirs and wells used for loading one or more samples onto the microfluidic device of the present invention, include but are not limited to, syringes, pipettes, cartridges, vials, eppendorf tubes and cell culture materials (e.g., 96 well plates). A reservoir may facilitate introduction of molecules or cells into the device and into the sample inlet channel of each analysis unit.

### Fluidic Interconnects

The microfluidic device can include a pipette, a syringe (or other glass container), or a tubing that is treated to affect the surface functionalization. The purpose for treating the walls of glass containers (e.g., syringes) with a functionality is to prevent biological adhesion to the inner walls of the container, which frustrates the proper transfer of biological/chemical materials into the microfluidic device of the present invention. The inlet channel is further connected to a fluid transport mechanism or other apparatus or means for introducing a sample to said device. The apparatus/means can be a well or reservoir. The apparatus/means can be temperature controlled. The inlet module may also contain a connector adapted to receive a suitable piece of tubing, such as liquid chromatography or HPLC tubing, through which a sample may be supplied. Such an arrangement facilitates introducing the sample solution under positive pressure in order to achieve a desired infusion rate at the inlet module.

The interconnections, including tubes, may be extremely clean and make excellent bonding with the surface in order to allow proper operation of the device. The difficulty in making a fluidic connection to a microfluidic device is primarily due to the difficulty in transitioning from a macroscopic fluid line into the device while minimizing dead volume.

The tubing side of the interconnect can be mounted into a retaining block that provides precise registration of the tubing, while the microfluidic device can be positioned accurately in a carrier that the retaining block would align and clamp to. The total dead volume associated with these designs would be critically dependent on how accurately the two mating surfaces could be positioned relative to each other. The maximum force required to maintain the seal would be limited by the exact shape and composition of the sealing materials as well as the rigidity and strength of the device itself. The shapes of the mating surfaces can be tailored to the minimal leakage potential, sealing force required, and potential for misalignment. By way of non-limiting example, the single ring indicated in can be replaced with a series of rings of appropriate cross-sectional shape.

Reservoirs and wells used for loading one or more samples onto the microfluidic device of the present invention include but are not limited to pipettes, syringes, cartridges, vials, eppendorf tubes and cell culture materials (e.g., 96 well plates) as described above. One of the issues to be resolved in loading samples into the inlet channel at the inlet module of the substrate is the size difference between the loading means or injection means, e.g., capillary or HPLC tubing and the inlet channel. It is necessary to create an interconnect and loading method which limits leaks and minimizes dead volume and compliance problems. Several devices and methods described in further detail herein address and solve these art problems.

### Self-Aligning Fluidic Interconnects

The present invention includes one or more inlet modules including self-aligning fluidic interconnects proximate to one or more inlet channels to improve the efficiency of sample loading and/or injection.

The present invention proposes the use of small interconnects based on creating a radial seal instead of a face seal between the microfluidic device and interconnect. The inserted interconnect would have a larger diameter than the mating feature on the device. When inserted, the stretching of the chip would provide the sealing force needed to make a leak-free seal between the external fluid lines and the microfluidic device.

In order to handle instrument and chip manufacturing tolerances, the external interconnect should be self-aligning and the “capture radius” of the molded hole should be large enough to reliably steer the interconnect to the sealing surfaces. The external interconnect could be made directly out of the tubing leading up to the microfluidic substrate, thus eliminating potential leak points and unswept volumes. The external interconnect is made from a hard but flexible material such as 1/32″ PEEK tubing. The features in the microfluidic device can be molded directly into it during the manufacturing process, while the inserted seals can be molded/machined directly onto the tubing ends or molded as individual pieces and mechanically fastened to the tubing. The ferrule could be an off-the-shelf component or a custom manufactured part and be made from, for example, a polymer, an elastomer, or a metal. The tubing end could be tapered on the end (top most diagram) or squared off (the figure above). The specific shape of the end will be controlled by how easily the microfluidic device will gall during insertion.

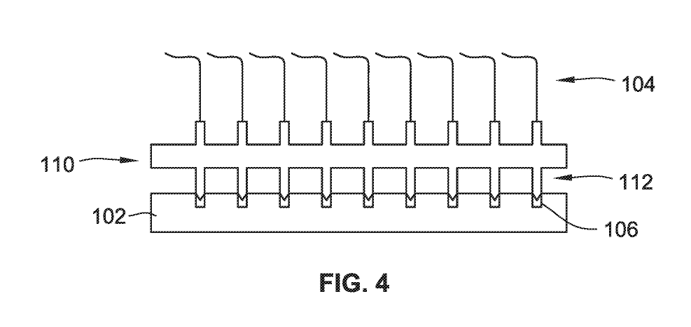

Alternatively, it is also possible to mold all the interconnects needed for each tube into a single monolithic self-aligned part, as detailed in FIG. 4. This may help reduce the difficulty in maintaining alignment of many external fluidic lines to the chip.

### Elastomeric Fluid Interconnects

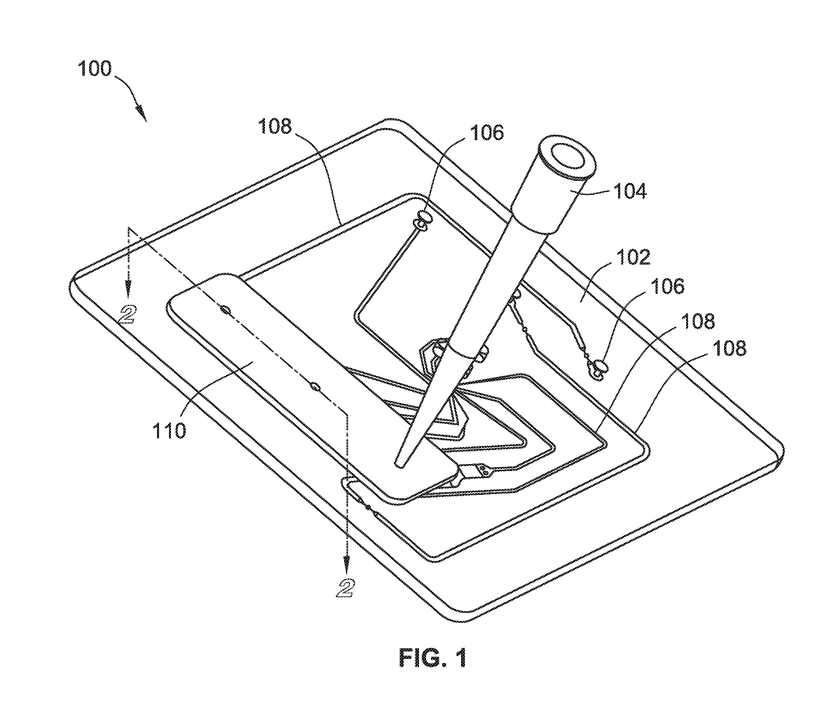

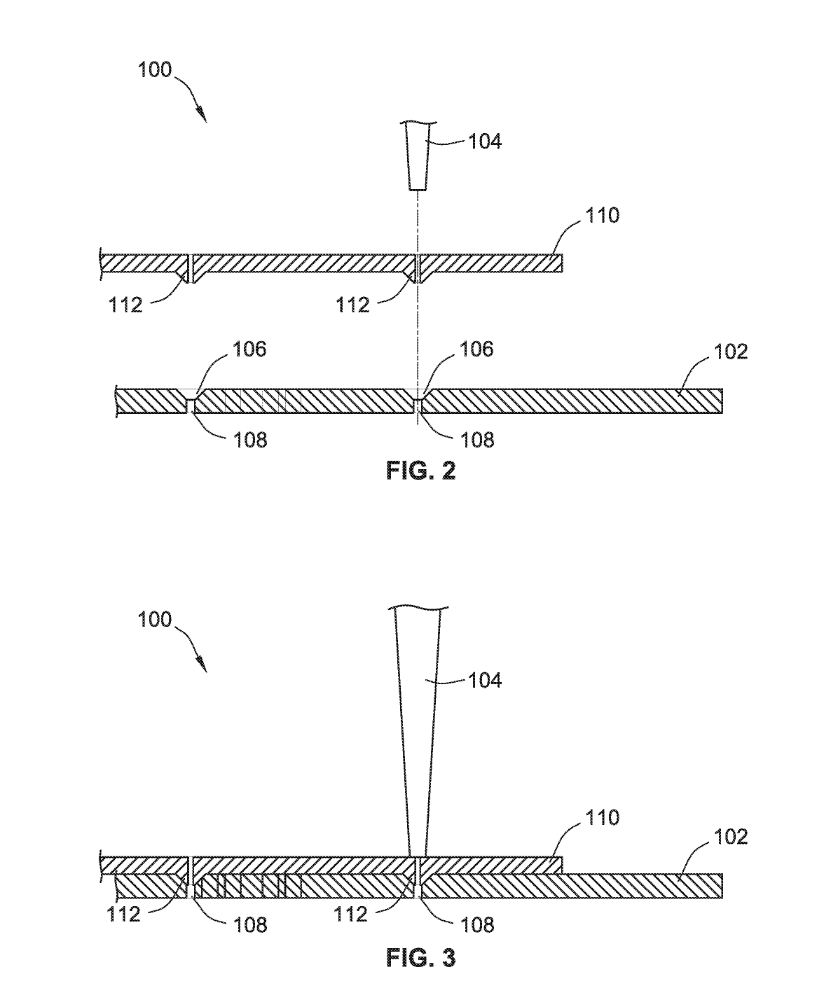

A microfluidic chip 100 having an elastomeric radial seal 110 (also referred to herein as a “gasket 110”) interface between the fluidic plate 102 and a fluid transport mechanism 104 (e.g., a pipette or tubing) for introducing a sample is shown in FIG. 1. A cross section of the microfluidic chip 100 depicted in FIG. 1 is shown in FIG. 2. As shown in FIG. 2, the fluidic plate 102 contains one or more ports 106 that include a tapered lead directly into a microfluidic channel 108. The elastomeric gasket 110 includes one or more tapered bosses 112 that are configured to fit within the one or more ports 106 of the microfluidic chip 100.

As shown in FIG. 3, the downward force of the sample introduction means or fluid transport mechanism 104 (e.g., a pipette or tubing) radially compresses (Z force) the gasket 110, thereby creating a seal between the gasket 110 and the port 106 in the fluidic plate 102. The gasket 110 can be loosely aligned with the one or more port 106 structures prior to sealing by the radial compression applied by the fluid transport mechanism 104. Optionally, the microfluidic chip 100 can be staked (e.g., heat bonded, glued, or clamped) to a carrier prior to sealing to facilitate insertion of the assembly into an instrument for analysis. Staking of the microfluidic chip 100 to a carrier apparatus causes axial compression against the gasket 110 to further induce sealing between the gasket 110 and port 106. However, axial compression is not required. The radial compression by the fluid transport mechanism 104 is sufficient to seal the gasket.

The design depicted in FIGS. 1-3 minimizes the requirements on precision of the fluid interface, and can accommodate many options for materials of different durometer. Although the design depicted in FIGS. 1-3 requires an additional mold to produce the gasket 110, and post-mold assembly with the fluidic plate 102, assembly/alignment of the loose parts is not expected to add any significant complexity to the assembly. Furthermore, the design keeps a planar part for ease of bonding and creates all disposable wetted parts to eliminate any cross contamination.

Shifting focus now to the ports 106 within the microfluidic chip 100, the port 106s can be configured to accommodate a variety of different shapes and sizes of different types of fluid transport mechanisms 104. For example, the bosses 112 within the gasket 110 can be designed to accommodate tubing (e.g., PEEK tubing), a 10 μL pipette, a 25 μL pipette, a 50 μL pipette, a 100 μL pipette, a 500 μL pipette, a 1000 μL pipette, and the like.

It should be noted that a portion of the gasket 110 is configured to fit at least partially into a port 106, while another portion of the gasket 110 is configured to sealingly receive the fluid transport mechanism 104 (e.g., tubing) for introducing a sample fluid. In particular, a bottom portion of the tapered bosses 112 formed within the gasket 110 is configured to align and fit at least partially within the ports 106 in the fluidic plate 102. Top portions of the same bosses 112 receive the fluid transport mechanism 104 (e.g., a tube or pipette). As such, the bosses 112 within the gasket 110 should be of similar dimensions and angles as the ports 106 with which they are aligned.

In certain embodiments, the microfluidic chip 100 is housed within a carrier apparatus. A carrier apparatus can be useful for stacking the microfluidic chips 100 within an instrument, particularly a robotic instrument. The carrier apparatus can include information, such as a bar code to identify particular sample fluids and/or experiments being conducted within the microfluidic chip 100. Alternatively, a bar code can be printed directly on the microfluidic chip 100.

Where a carrier apparatus is used, the microfluidic chip 100 can be held within the carrier apparatus by a clamp, or can be heat-staked or glued to the carrier apparatus. Clamping, heat-staking or gluing the microfluidic chip 100 to the carrier apparatus provides axial compression against the gasket 110 to help induce a fluid-tight seal at the fluid interface, in addition to the radial compression provided against the gasket 110 by insertion of a fluid transport mechanism 104 into a boss 112. However, it should be noted that axial compression against the gasket 110 is not necessary to induce a fluid-tight seal at the fluid interface. A sufficiently strong seal (e.g., able to hold pressure up to 100 psi) can be created by radial compression only against the gasket 110.

The microfluidic chip 100/carrier apparatus can be assembled in a variety of configurations.

In Configuration 1, the fluidic plate 102 and the gasket 110 are injection molded separately and assembled within a 2-piece or 1-piece carrier apparatus, depending on whether a clamp is used to fix the chip 100 within the carrier apparatus (i.e., a 2 piece carrier). The microfluidic chip 100 includes a top plate and a bottom plate that are bonded together. The top and bottom plates are of uniform thickness (e.g., 1.7 mm). The bottom plate has microfluidic channels 108 molded or etched into the plate. The top plate includes ports 106 that lead directly into the microfluidic channels 108 when the top plate is fitted over the bottom plate. The gasket 110 is fitted over the top plate, the bosses 112 being aligned with the ports 106 in the top plate. The chip 100 is inserted into a carrier apparatus. A clamp can be used to fix the chip 100 to the carrier apparatus (2 piece carrier) and provide axial compression against the gasket 110. Alternatively, the chip 100 can be heat-staked or glued to the carrier apparatus (1 piece carrier).

The plate 102 and gasket 110 can be injection molded as individual components that are assembled together. Alternatively, the gasket 110 can be overmolded directly onto the fluidic plate 102. For example, the gasket 110 can be overmolded onto the entire surface of the fluidic plate 102, with tapered bosses 112 aligned with the ports 106 within the fluidic plate 102, or the gasket 110 can be overmolded within each individual port 106 within the fluidic plate 102. The carrier apparatus and clamp can also be injection molded from a variety of materials.

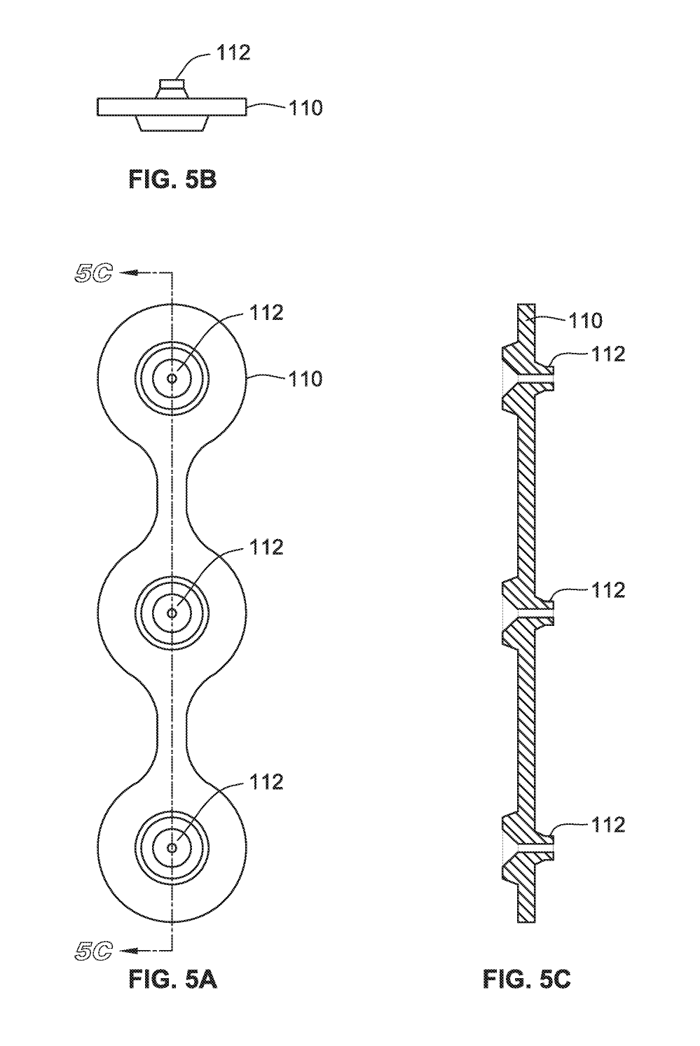

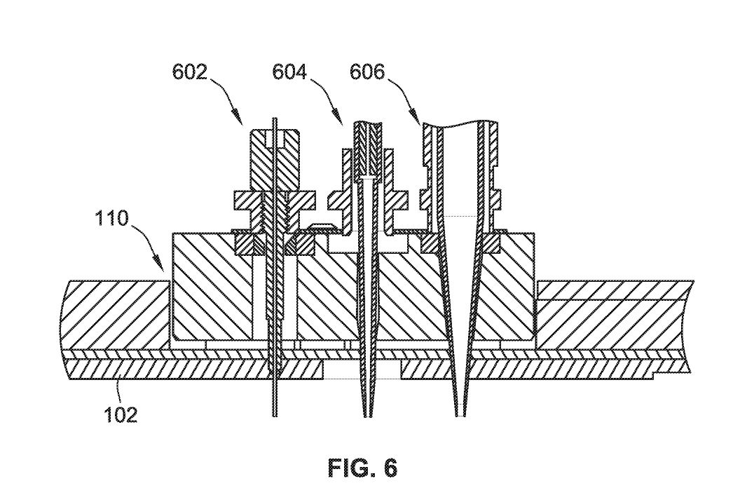

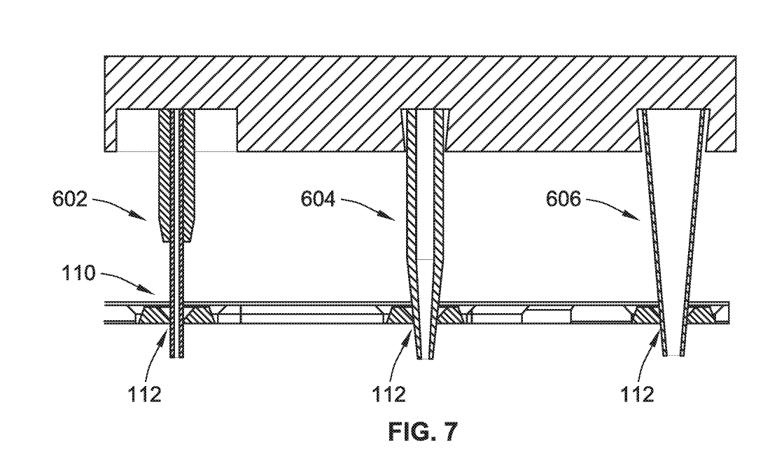

A preferred embodiment of a gasket 110 for use in a microfluidic chip 100 is depicted in FIGS. 5A-5C. FIGS. 6 and 7 depict the preferred embodiment of a fluid interface with the microfluidic chip 100 using the gasket 110 depicted in FIGS. 5A-5C. In this particular embodiment, the gasket 110 is injection molded using Genomier® 200. The gasket 110 is then assembled to a fluidic plate 102 having three ports 106 that align with the bosses 112 on the gasket 110. As shown in FIGS. 6 and 7, the chip 100 is configured to accommodate a variety of fluid transport mechanisms 104, including PEEK tubing 602, a 50 uL pipette 604, and a 1 mL pipette 606. It should be noted that one or more of the gaskets 110 depicted in FIGS. 5A-5C can be assembled within a microfluidic chip 100, so long as the chip 100 has an appropriate number of corresponding ports 106 to align with the bosses 112 on the gaskets 110.

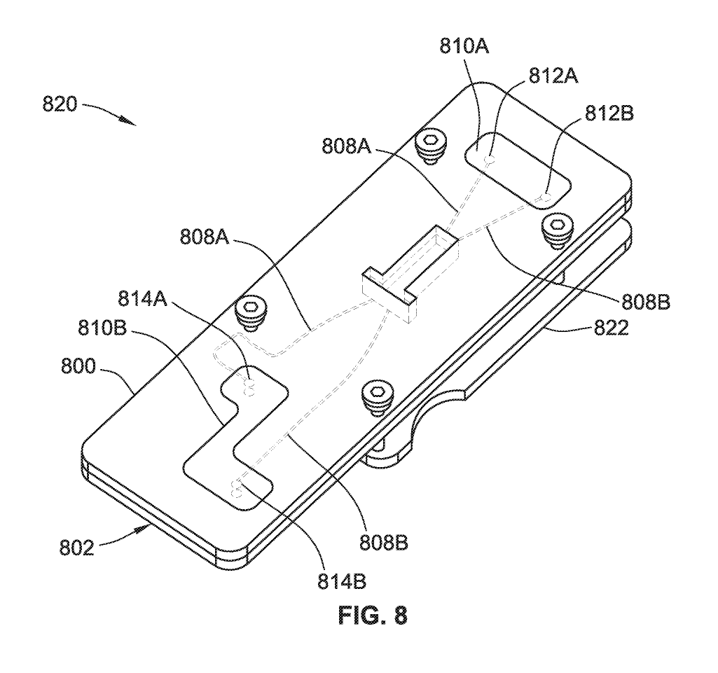

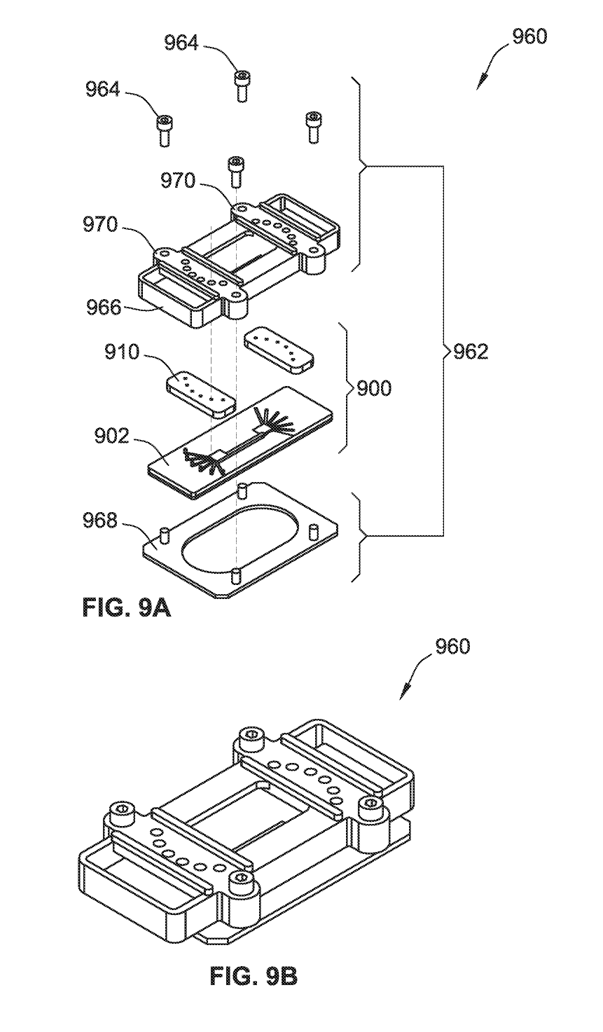

FIG. 8 shows a disposable cartridge 820 for use with a microfluidic analysis system in accord with aspects of the present disclosure. The disposable cartridge 820 includes a carrier 822 and a microfluidic device 800 coupled to the carrier 822. For example, the microfluidic device 800 includes a fluidic plate 802 defining at least two internal channels 808A and 808B and also defining a first inlet port 812A and a first outlet port 814A of a first one of the channels 808A, a second inlet port 812B and a second outlet port 814B of a second one of the channels 808B. A first gasket 810A is associated with the first and second inlet ports 812A and 812B and configured to sealingly receive an fluid transport mechanism such that fluid exits a tip of the mechanism and enters one of the first and second channels 808A and 808B via one of the first and second inlet ports 812A and 812B. A second gasket 810B is associated with the first and second outlet ports 814A and 814B and configured to sealingly receive an fluid transport mechanism such that fluid exits one of the first and second channels 808A and 808B via one of the first and second outlet ports 814A and 814B and enters a tip of the fluid transport mechanism.

In one embodiment, the microfluidic chips are generally designed as a single-use, disposable chips, to avoid cross-contamination in biological, chemical and diagnostic assays. The gaskets described herein can be disposable with the chips to avoid fluid loss and cross-contamination. Unlike previous fluid interface designs for pressure-driven microfluidic systems in which manufacturing of the interface can be complicated and expensive (e.g., Luer-Loc systems in which connection requires a twisting motion), the gaskets described herein can be injection molded and are easily assembled with a microfluidic chip, or can be overmolded directly onto the microfluidic chip.

### Detection Module

The microfluidic devices of the present invention can also include one or more detection modules. A “detection module” is a location within the device, typically within the main channel where molecules, cells, or small molecules are to be detected, identified, measured or interrogated on the basis of at least one predetermined characteristic. The molecules, cells, or small molecules can be examined one at a time, and the characteristic is detected or measured optically, for example, by testing for the presence or amount of a reporter. For example, the detection module is in communication with one or more detection apparatuses. The detection apparatuses can be optical or electrical detectors or combinations thereof. Examples of suitable detection apparatuses include optical waveguides, microscopes, diodes, light stimulating devices, (e.g., lasers), photo multiplier tubes, and processors (e.g., computers and software), and combinations thereof, which cooperate to detect a signal representative of a characteristic, marker, or reporter, and to determine and direct the measurement or the sorting action at the sorting module. However, other detection techniques can also be employed.

The term “determining,” as used herein, generally refers to the analysis or measurement of a species, for example, quantitatively or qualitatively, and/or the detection of the presence or absence of the species. “Determining” may also refer to the analysis or measurement of an interaction between two or more species, for example, quantitatively or qualitatively, or by detecting the presence or absence of the interaction. Examples of suitable techniques include, but are not limited to, spectroscopy such as infrared, absorption, fluorescence, UV/visible, FTIR (“Fourier Transform Infrared Spectroscopy”), or Raman; gravimetric techniques; ellipsometry; piezoelectric measurements; immunoassays; electrochemical measurements; optical measurements such as optical density measurements; circular dichroism; light scattering measurements such as quasielectric light scattering; polarimetry; refractometry; or turbidity measurements as described further herein.

A detection module is within, communicating or coincident with a portion of the main channel at or downstream of the inlet module and, in sorting embodiments, at, proximate to, or upstream of, the sorting module or branch point. The sorting module may be located immediately downstream of the detection module or it may be separated by a suitable distance consistent with the size of the molecules, the channel dimensions and the detection system. Precise boundaries for the detection module are not required, but are preferred.

Detection modules used for detecting molecules and cells have a cross-sectional area large enough to allow a desired molecule, cells, bead, or particles to pass through without being substantially slowed down relative to the flow carrying it. The dimensions of the detection module are influenced by the nature of the sample under study and, in particular, by the size of the molecules or cells under study. For example, mammalian cells can have a diameter of about 1 to 50 microns, more typically 10 to 30 microns, although some mammalian cells (e.g., fat cells) can be larger than 120 microns. Plant cells are generally 10 to 100 microns. However, other molecules or particles can be smaller with a diameter from about 20 nm to about 500 nm.

### Mixing Module

The microfluidic devices of the present disclosure can further include one or more mixing modules. Although coalescence of one or more droplets in one or more coalescence modules can be sufficient to mix the contents of the coalesced droplets (e.g., through rotating vortexes existing within the droplet), it should be noted that when two droplets fuse or coalesce, perfect mixing within the droplet does not instantaneously occur. Instead, for example, the coalesced droplet may initially be formed of a first fluid region (from the first droplet) and a second fluid region (from the second droplet). Thus, in some cases, the fluid regions may remain as separate regions, for example, due to internal “counter-revolutionary” flow within the fluidic droplet, thus resulting in a non-uniform fluidic droplet. A “mixing module” can comprise features for shaking or otherwise manipulate droplets so as to mix their contents. The mixing module is preferably downstream from the coalescing module and upstream from the detection module. The mixing module can include, but is not limited to, the use of channel geometries, acoustic actuators, metal alloy component electrodes or electrically conductive patterned electrodes to mix the contents of droplets and to reduce mixing times for fluids combined into a single droplet in the microfluidic device. For example, the fluidic droplet may be passed through one or more channels or other systems which cause the droplet to change its velocity and/or direction of movement. The change of direction may alter convection patterns within the droplet, causing the fluids to be at least partially mixed. Combinations are also possible.

For acoustic manipulation, the frequency of the acoustic wave should be fine-tuned so as not to cause any damage to the cells. The biological effects of acoustic mixing have been well studied (e.g., in the ink-jet industry) and many published literatures also showed that piezoelectric microfluidic device can deliver intact biological payloads such as live microorganisms and DNA. There are five parameters to optimize beyond the frequency parameter. Lab electronics is used to optimize the piezoelectric driving waveform. Afterwards, a low cost circuit can be designed to generate only the optimized waveform in a preferred microfluidic device.

### A Preferred Embodiment

The gaskets of the present disclosure can be affixed to the chips in a variety of ways including bonding (e.g., solvent bonding, pressure-sensitive adhesives, glues, etc.), molding the gaskets in place (such as in 2k molding), or by compressing the gaskets to the chips using an additional element.

An example of a rigid-chip interface constructed using a gasket and an additional clamping element is shown in FIGS. 9A, 9B, and 10. FIGS. 9A and 9B show a rigid-chip interface system 960. The system 960 in this example is constructed using micruofludic chip 900 that includes a gasket 910 that is affixed to a fluidic plate 902 using a clamping/compressing assembly 962. The assembly 962 includes fasteners 964, such as bolts or other mechanical fasteners, a frame 966, and a clamping plate 968. The frame 966 can include openings 970 that provide access to the gaskets 910 if, for example, the frame 966 at least partially covers the gaskets 910. The gaskets 910 and fluidic plate 902 of microfluidic chip 900 fit between the frame 966 and the clamping plate 968. The fasteners 964 couple and secure the frame 966 and the clamping plate 968 together with the chip 900 there between.

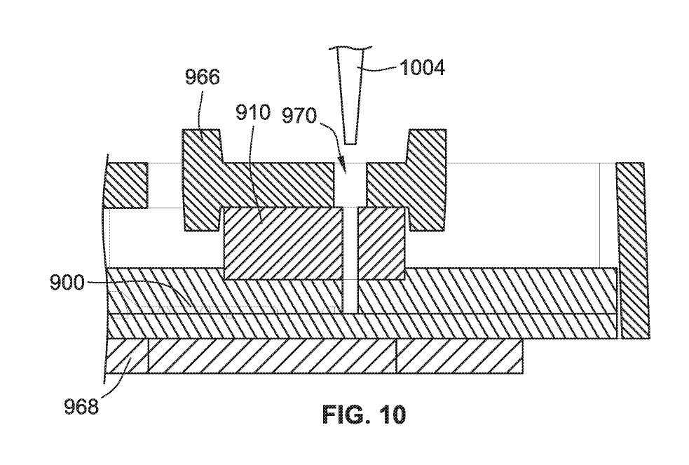

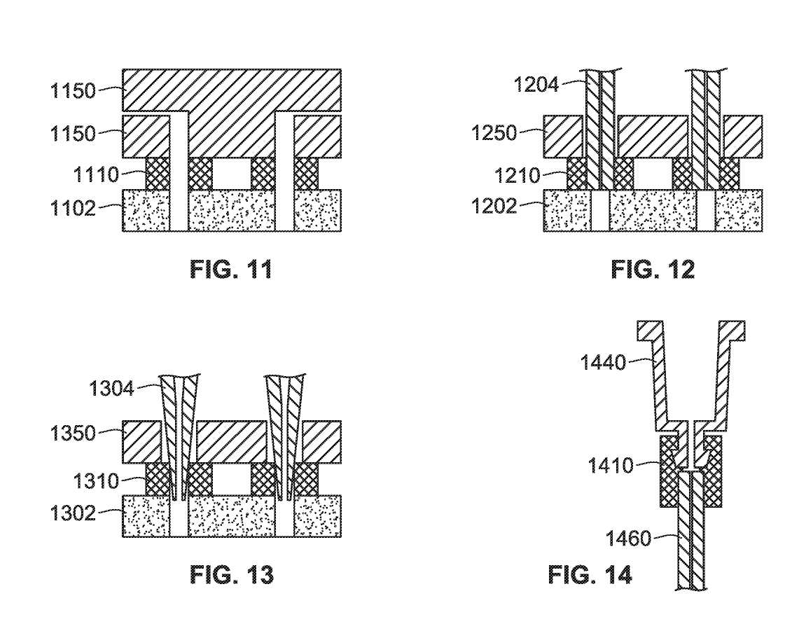

FIG. 10 shows an illustration of the interface system 960 of FIGS. 9A and 9B in use. A standard pipette tip 1004 can be pressed into the gasket 910 to create a radial seal. In particular, a single gasket can be designed to accommodate multiple modes of interface, for example, allowing both attachment of a chip to a cartridge (face seal) as well as allowing the chip to be accessed by a pipette tip (radial seal). This is very useful in practice, since it allows for seeding chips using pipette tips before attaching to cartridges, which is only attached later. Illustrations of how various components can make fluidic seals against such a gasket, illustrating the versatility of this approach are seen in FIGS. 11-13.

FIG. 11 shows a cross-section view of a gasket 1110 making a face-seal between a fluidic plate 1102 and a cartridge 1120, in accord with aspects of the present disclosure. FIG. 12 shows a cross-section view of a gasket 1210 making a face-seal against a fluidic plate 1202 and a radial seal against an inserted fluid transport mechanism 1204 (e.g., tube or nozzle), in accord with aspects of the present disclosure. FIG. 13 shows a gasket 1310 making a face-seal against a fluidic plate 1302 and a radial seal with a fluid transport mechanism 1304 (e.g., pipette tip), in accord with aspects of the present disclosure. Although FIGS. 11-13 show this flexibility as pertaining to the top side of the gaskets, the same flexibility can exist on the opposing side. Consequently, the gaskets can be used as a fluidic adapter between a variety of cartridge components. An example is illustrated in FIG. 14.

FIG. 14 shows a gasket 1410 used as part of cartridge construction (cartridge not shown) to make a radial-seal between a first component (a barbed fitting 1440) and a radial seal with a second component (a tube or nozzle 1460). A particular example is a pressure-driven cartridge that uses capillary tubes as fluidic resistors (previously disclosed). In this example, the capillary tubes can be connected to input and output reservoirs with barbed fittings using an intermediate gasket, as shown in FIG. 14. When used for cartridge construction, the cartridge can employ a gasket or a sheet that acts to connect multiple components like a sort of fluidic breadboard. This approach can greatly simplify gasket manufacture and mounting as well as cartridge assembly: the cartridge may be assembled by literally plugging in the various components into the gasket “breadboard”.

Variations and Optional Features are possible. To improve the task for affixing a gasket to a chip, especially when the gasket is clamped on, as in FIGS. 9A, 9B, and 10, the face-seal can be enhanced by adding a pressure concentrator around the fluidic ports. The pressure concentrator can take the form of a raised bump that concentrates the sealing pressure in the region where the fluid seal is to be created. The gasket does not have to be a planar. Fluidic seals can be improved, for example, by including cone geometries or o-ring like geometries. These may create face-, radial- or hybrid-seals against the chip or coupled component, which may be desired (for example, to reduce sealing force). In a particular example, the gaskets may be or comprise o-rings. In other examples, different gasket elements can be mechanically connected to each other to reduce part count and potentially enable manufacture as one component. In one embodiment, the same gasket could be used to provide two kinds of sealing against two different fluidic transport mechanisms (e.g., radial seal against a pipette and face seal against a cartridge).

Another innovation of the present invention includes: a method for interfacing to otherwise rigid chips, which provides a great deal of flexibility, a system for retaining a gasket against a chip, a method for cartridge construction wherein components are connected via a gasket, and an object connected can be interchanged during use (e.g., changes in inputs like first plugging in pipette tips for cell seeding, then connecting to a cartridge).

### Methods

The microfluidic devices of the present invention can be utilized to conduct numerous chemical and biological assays. In one embodiment, the SEBS gaskets may be used in conjunction with other microfluidic devices, systems and methods.

While embodiments and applications have been shown and described, it would be apparent to those skilled in the art having the benefit of this disclosure that many more modifications than mentioned above are possible without departing from the inventive concepts disclosed herein. The embodiment(s), therefore, are not to be restricted except in the spirit of the appended claims.

The present inventive subject matter can be defined in any of the following alphabetized paragraphs:

[A] An organomimetic device comprising: a body having a central microchannel therein; and an at least partially porous membrane positioned within the central microchannel and along a plane, the membrane configured to separate the central microchannel to form a first central microchannel and a second central microchannel, wherein a first fluid is applied through the first central microchannel and a second fluid is applied through the second central microchannel, the membrane coated with at least one attachment molecule that supports adhesion of a plurality of living cells.

[B] The device of [A] wherein the porous membrane is at least partially flexible, the device further comprising: a first chamber wall of the body positioned adjacent to the first and second central microchannels, wherein the membrane is mounted to the first chamber wall; and a first operating channel adjacent to the first and second central microchannels on an opposing side of the first chamber wall, wherein a pressure differential applied between the first operating channel and the central microchannels causes the first chamber wall to flex in a first desired direction to expand or contract along the plane within the first and second central microchannels.

[C] The device of [A] or [B] further comprising: a second chamber wall of the body positioned adjacent to the first and second central microchannels, wherein an opposing end of the membrane is mounted to the second chamber wall; and a second operating channel positioned adjacent to the central microchannel on an opposing side of the second chamber wall, wherein the pressure differential between to the second operating channel and the central microchannels causes the second chamber wall to flex in a second desired direction to expand or contract along the plane within the first and second central microchannels.

[D] The device of any or all of the above paragraphs wherein at least one pore aperture in the membrane is between 0.5 and 20 microns along a width dimension.

[E] The device of any or all of the above paragraphs wherein the membrane further comprises a first membrane and a second membrane positioned within the central microchannel, wherein the second membrane is oriented parallel to the first membrane to form a third central microchannel therebetween.

[F] The device of any or all of the above paragraphs contains one or more ports in fluidic communication with one or more channels, wherein the ports comprise a SEBS gasket,

[G] The device of any or all of the above paragraphs wherein the membrane is coated with one or more cell layers, wherein the one or more cell layers are applied to a surface of the membrane.

[H] The device of any or all of the above paragraphs wherein one or both sides of the membrane are coated with one or more cell layers, wherein the one or more cell layers comprise cells selected from the group consisting of metazoan, mammalian, and human cells.

[I] The device of any or all of the above paragraphs, wherein the cells are selected from the group consisting of epithelial, endothelial, mesenchymal, muscle, immune, neural, and hemapoietic cells.

[J] The device of any or all of the above paragraphs wherein one side of the membrane is coated with epithelial cells and the other side of the membrane is coated with endothelial cells.

[K] The device of any or all of the above paragraphs wherein the body of the device and the membrane are made of a biocompatible or biodegradable material.

[L] The device of any or all of the above paragraphs wherein the device is further implanted to a living organism.

[M] The device of any or all of the above paragraphs wherein the living organism is a human.

[N] The device of any or all of the above paragraphs wherein the membrane is coated with the one or more cell layers in vitro.

[O] The device of any or all of the above paragraphs, wherein the at least one membrane is coated with the one or more cell layers in vivo.

[P] The device of any or all of the above paragraphs, wherein the membrane is coated with a biocompatible agent which facilitates attachment of the at least one cell layer onto the membrane.

[Q] The device of any or all of the above paragraphs wherein the biocompatible agent is extracellular matrix comprising collagen, fibronectin and/or laminin.

[R] The device of any or all of the above paragraphs wherein the biocompatible material is selected from the group consisting of collagen, laminin, proteoglycan, vitronectin, fibronectin, poly-D-lysine and polysaccharide.

[S] The device of any or all of the above paragraphs wherein the first fluid contains white blood cells.

[T] A method comprising: selecting a organomimetic device having a body, the body including an at least partially porous membrane positioned along a plane within a central microchannel to partition the central microchannel into a first central microchannel and a second central microchannel, the membrane coated with at least one attachment molecule that supports adhesion of a plurality of living cells; applying a first fluid through the first central microchannel; applying a second fluid through the second central microchannel; and monitoring behavior of cells with respect to the membrane between the first and second central microchannels.

[U] The method of any or all of the above paragraphs wherein the membrane is at least partially elastic and the body includes at least one operating channel positioned adjacent to the first and second central microchannels, the method further comprising: adjusting a pressure differential between the central microchannels and the at least one operating channels, wherein the membrane stretches along the plane in response to the pressure differential.

[V] The method of any or all of the above paragraphs wherein the adjusting of the pressure differential further comprises: increasing the pressure differential such that one or more sides of the membrane move in desired directions along the plane; and decreasing the pressure differential such that the one or more sides of the membrane move in an opposite direction along the plane.

[W] The method of any or all of the above paragraphs wherein at least one pore aperture in the membrane is between 0.5 and 20 microns along a width dimension.

[X] The method of any or all of the above paragraphs further comprising treating the membrane with one or more cell layers, wherein the one or more cell layers are applied to a surface of the membrane.

[Y] The method of any or all of the above paragraphs further comprising applying one or more cell layers onto one or both sides of the membrane, wherein the one or more cell layers comprise cells selected from the group consisting of metazoan, mammalian, and human cells.

[Z] The method of any or all of the above paragraphs wherein the cells are selected from the group consisting of epithelial, endothelial, mesenchymal, muscle, immune, neural, and hemapoietic cells.

[AA] The method of any or all of the above paragraphs wherein one side of the membrane is coated with epithelial cells and the other side of the membrane is coated with endothelial cells.

[BB] The method of any or all of the above paragraphs wherein the body of the device and the membrane are made of a biocompatible or biodegradable material.

[CC] The method of any or all of the above paragraphs wherein the device is further implanted to a living organism.

[DD] The method of any or all of the above paragraphs wherein the living organism is a human.

[EE] The method of any or all of the above paragraphs wherein the membrane is coated with the one or more cell layers in vitro.

[FF] The method of any or all of the above paragraphs wherein the at least one membrane is coated with the one or more cell layers in vivo.

[GG] The method of any or all of the above paragraphs wherein the membrane is coated with a biocompatible agent which facilitates attachment of the at least one cell layer onto the membrane.

[HH] The method of any or all of the above paragraphs wherein the biocompatible agent is extracellular matrix comprising collagen, fibronectin and/or laminin.

[II] The method of any or all of the above paragraphs wherein the biocompatible material is selected from the group consisting of collagen, laminin, proteoglycan, vitronectin, fibronectin, poly-D-lysine and polysaccharide.

[JJ] The method of any or all of the above paragraphs wherein the first fluid contains white blood cells.

[KK] A method for determining an effect of at least one agent in a tissue system with physiological or pathological mechanical force, the method comprising: selecting a device having a body, the body including an at least partially porous membrane positioned along a plane within a central microchannel to partition the central microchannel into a first central microchannel and a second central microchannel; contacting the membrane with at least one layer of cells on a first side of the membrane and at least one layer of cells on a second side of the porous membrane thereby forming a tissue structure comprising at least two different types of cells; contacting the tissue structure comprising at least two different types of cells with the at least one agent in an applicable cell culture medium; applying uniform or non-uniform force on the cells for a time period; and measuring a response of the cells in the tissue structure comprising at least two different types of cells to determine the effect of the at least one agent on the cells.

[LL] The method of any or all of the above paragraphs wherein the applicable cell culture medium is supplemented with white blood cells.

[MM] The method of any or all of the above paragraphs wherein the uniform or non-uniform force is applied using vacuum.

[NN] The method of any or all of the above paragraphs wherein the tissue structure comprising at least two different types of cells comprises alveolar epithelial cells on the first side of the porous membrane and pulmonary microvascular cells on the second side of the porous membrane.

[OO] The method of any or all of the above paragraphs wherein the agent is selected from the group consisting of nanoparticles, environmental toxins or pollutant, cigarette smoke, chemicals or particles used in cosmetic products, drugs or drug candidates, aerosols, naturally occurring particles including pollen, chemical weapons, single or double-stranded nucleic acids, viruses, bacteria and unicellular organisms.

[PP] The method of any or all of the above paragraphs wherein the measuring the response is performed by measuring expression of reactive oxygen species.

[QQ] The method of any or all of the above paragraphs wherein the measuring the response is performed using tissue staining.

[RR] The method of any or all of the above paragraphs further comprising prior to measuring the effect of the agent, taking a biopsy of the membrane comprising tissue structure comprising at least two different types of cells, wherein the biopsy is stained.

[SS] The method of any or all of the above paragraphs wherein the measuring the response is performed from a sample of the cell culture medium in contact wherein the measuring the response is performed from a sample of the cell culture medium in contact with the first or the second or both sides of the membrane form tissue structure comprising at least two different types of cells. with the first or the second or both sides of the membrane comprising tissue structure comprising at least two different types of cells.

[TT] The method of any or all of the above paragraphs further comprising comparing the effect of the agent to another agent or a control without the agent in a similar parallel device system.

[UU] The method of any or all of the above paragraphs further comprising a step of contacting the membrane with at least two agents, wherein the first agent is contacted first to cause an effect on the tissue structure comprising at least two different types of cells and the at least second agent in contacted after a time period to test the effect of the second agent on the tissue structure comprising at least two different types of cells affected with the first agent.

[VV] An organomimetic device comprising: a body having a central microchannel; and a plurality of membranes positioned along parallel planes in the central microchannel, wherein at least one of the plurality of membranes is at least partially porous, the plurality of membranes configured to partition the central microchannel into a plurality of central microchannels.

Thus, specific compositions and methods of elastomeric gasket for fluid interface to a microfluidic chip have been disclosed. It should be apparent, however, to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Although the invention has been described with reference to these preferred embodiments, other embodiments can achieve the same results. Variations and modifications of the present invention will be obvious to those skilled in the art and it is intended to cover in the appended claims all such modifications and equivalents.

1. A microfluidic device comprising:
a member defining at least one internal channel and at least one port in fluid communication with each of the at least one channel; and
a gasket associated with the at least one port and configured to sealingly receive a fluid transport mechanism comprising fluid, such that the fluid can exit the fluid transport mechanism and enter one of the at least one channel, or such that the fluid can exit the one of the at least one channel and enter the fluid transport mechanism.

2. The microfluidic device of claim 1, wherein the fluid transport mechanism is a pipette or a tube.

3. The microfluidic device of claim 1, wherein at least a portion of the gasket fits at least partially into the at least one port.

4. The microfluidic device of claim 1, wherein at least a portion of the gasket is retained against the member by a substrate.

5. The microfluidic device of claim 1, wherein at least a portion of the gasket is bonded to the member.

6. The microfluidic device of claim 1, wherein the member comprises a top piece adhered to a bottom piece.

7. The microfluidic device of claim 6, wherein the bottom piece defines the at least one channel and the top piece defines the at least one port.

8. The microfluidic device of claim 1, wherein the gasket comprises an elastomeric material comprised of styrene ethylene butylene styrene.

9. A method of engaging a microfluidic device with a fluid transport mechanism, comprising:
1) providing a) the fluid transport mechanism comprising fluid, wherein the fluid transport mechanism is a pipette or a tube, b) a cartridge comprising at least one channel, and b the microfluidic device, the microfluidic device comprising i) a member defining ii) at least one internal channel and iii) at least one port in fluid communication with each of the at least one channel, the microfluidic device further comprising iv) an elastomeric gasket associated with each of the at least one port, the gasket configured to sealingly engage the fluid transport mechanism;
2) sealingly engaging the microfluidic device with the fluid transport mechanism; and
3) sealingly engaging the microfluidic device with the same cartridge, so as to fluidically couple the said at least one channel of the said cartridge with at least one port of said microfluidic device.

10. The method of claim 9, wherein the engaging of step 2) is under conditions such that the fluid exits the fluid transport mechanism and enters one of the at least one channel.

11. The method of claim 9, wherein the engaging of step 2) is under conditions such that the fluid exits one of the at least one channel and enters the fluid transport mechanism.

12. The method of claim 9, wherein the engaging of step 3) occurs before the engaging of step 2.

13. The method of claim 9, wherein at least a portion of the gasket fits at least partially into the at least one port.

14. The method of claim 9, wherein at least a portion of the gasket is retained against the microfluidic device by a substrate.

15. The method of claim 9, wherein at least a portion of the gasket is bonded to the member.

16. The method of claim 9, wherein the member comprises a top piece adhered to a bottom piece.

17. The method of claim 16, wherein the bottom piece defines the at least one channel and the top piece defines the at least one port.

18. The method of claim 9, wherein the gasket comprises an elastomeric material comprised of styrene ethylene butylene styrene.

19. A cartridge for use with a microfluidic analysis system, comprising:
a) a carrier; and
b) a microfluidic device disposed within the carrier, the microfluidic device comprising i) a member defining ii) at least one internal channel and iii) at least one port in fluid communication with each of the at least one channel, the microfluidic device further comprising iv) an elastomeric face seal comprised of styrene ethylene butylene styrene.

20. The cartridge of claim 19, wherein the elastomeric face seal is a planar seal.

21. The cartridge of claim 19, wherein the elastomeric face seal is in contact with the carrier.

22. The cartridge of claim 19, wherein the elastomeric face seal comprises one or more microfluidic vias extending through the elastomeric face seal and in fluid connection with one or more of the at least one port.

23. The cartridge of claim 19, wherein the cartridge is disposable.

24. A method of engaging a microfluidic device, comprising:
a) providing i) the microfluidic device comprising at least one internal channel and at least one port in fluid communication with each of the at least one channel, ii) a gasket with openings, and iii) a clamping assembly with openings;
b) aligning the openings of the gasket and clamping assembly with the at least one port of the microfluidic device; and
c) engaging the microfluidic device with the gasket and clamping assembly under conditions such that the gasket is affixed to the microfluidic device by the clamping assembly.

25. The method of claim 24, wherein the clamping assembly comprises a manifold frame and a clamping plate.

26. The method of claim 25, wherein the manifold frame comprises the openings of the clamping assembly.

27. The method of claim 26, wherein the openings of the manifold frame are aligned with the openings of the gasket and the at least one port of the microfluidic device after step b).

28. The method of claim 27, wherein the manifold frame is positioned above the gasket, the gasket is positioned above the microfluidic chip, and the clamping plate is positioned below the microfluidic device after step c).

29. The method of claim 28, wherein the manifold frame and the clamping plate are connected with bolts.

30. The method of claim 28, further comprising d) introducing a fluid transport mechanism comprising fluid into an opening of said manifold frame under conditions such that the fluid transport mechanism protrudes into an aligned opening in the gasket above an aligned port of the microfluidic device, so as to create a radial seal.

31. The method of claim 30, further comprising e) causing the fluid to exit the fluid transport mechanism and enter one of the at least one channel of the microfluidic device.

32. The method of claim 30, wherein the fluid transport mechanism is a pipette or a tube.

33. An assembly comprising i) a manifold frame with openings, the manifold frame being positioned above and engaging ii) a gasket with openings, the openings being aligned with the openings of the manifold frame, the gasket being positioned above and engaging iii) a microfluidic device, the microfluidic device comprising at least one internal channel and at least one port in fluid communication with each of the at least one channel, the at least one port being aligned with the openings of the manifold frame and gasket, the microfluidic device being positioned above and engaging iv) a clamping plate.
